(19) United States
(12) Patent Application Publication
(10) Pub. No.: US 2015/0071294 A1
(43) Pub. Date: Mar. 12, 2015

(54) APPARATUS AND METHOD FOR DESIGNING A COMMUNICATION NETWORK PREVENTING OCCURRENCE OF MULTIPLE FAILURES

(71) Applicant: FUJITSU LIMITED, Kawasaki-shi (JP)

(72) Inventors: Takao NAITO, Musashino (JP); Kazuyuki TAJIMA, Yokosuka (JP); Yutaka TAKITA, Kawasaki (JP); Tomohiro HASHIGUCHI, Inagi (JP)

(73) Assignee: FUJITSU LIMITED, Kawasaki-shi (JP)

(21) Appl. No.: 14/457,386

(22) Filed: Aug. 12, 2014

(30) Foreign Application Priority Data
Sep. 11, 2013 (JP) 2013-188568

(51) Int. Cl. H04L 12/707; H04Q 11/00; H04L 12/24; H04L 12/751

(52) U.S. Cl. CPC H04L 45/22; H04L 45/02; H04Q 11/0066; H04L 41/14; H04Q 2011/0073; H04Q 2011/0081
USPC 370/400

(57) ABSTRACT

An apparatus generates plural communication-route candidates corresponding to a requested communication channel by combining first transmission-paths providing connections between particular nodes in a network and second transmission-paths providing connections between three or more nodes in the network, where the first transmission paths are accommodated in plural communication cables together with the second transmission paths. The apparatus holds a table indicating first and second association relationships, where the first association relationship associates the first transmission paths with communication cables that accommodate the first transmission paths and are provided at opposite ends of each of the first transmission-paths, and the second association relationship associates the second transmission paths with communication cables accommodating the second transmission paths. The apparatus determines, by referring to the table, from among the plural communication-route candidates, a communication-route candidate that uses a same communication cable multiple times, and excludes the determined communication-route candidate from the plural communication-route candidates.

### CROSS-REFERENCE TO RELATED APPLICATION

This application is based upon and claims the benefit of priority of the prior Japanese Patent Application No. 2013-188568 filed on Sep. 11, 2013, the entire contents of which are incorporated herein by reference.

### FIELD

The embodiment discussed herein is related to apparatus and method for designing a communication network preventing occurrence of multiple failures.

### BACKGROUND

With an increase in communication demand because of the widening use of cloud services, smartphones, and so on, optical networks utilizing wavelength division multiplexing (WDM) have come into widespread use. Wavelength division multiplexing is a technology for transmitting multiplexed optical signals having different wavelengths.

With wavelength division multiplexing, for example, optical signals with 88 wavelengths and a transmission speed of 40 Gbps can be multiplexed and transmitted as a wavelength-multiplexed optical signal (hereinafter referred to as a “multiplexed optical signal”). One known example of wavelength division multiplexing transmission equipment utilizing WDM is reconfigurable optical add-drop multiplexer (ROADM) equipment.

Although the transmission capacities of wavelength division multiplexing transmission equipment are increasing, the transmission capacities of optical fibers for transmitting multiplexed optical signals are limited. For example, the wavelength bands of light that propagates through optical fibers are limited because of the physical properties of the optical fibers. Examples of the wavelength bands include the conventional band (C band) and the long band (L band).

In recent years, with anticipation of an increase in future communication demand, attempts are being made to realize coherent transmission by applying a polarization multiplexing (dual polarization) system or a multilevel modulation system, such as quaternary phase-shift keying (QPSK) used for wireless communication, to wavelength division multiplexing transmission equipment. In order to increase the communication capacity, a multilevel modulation system for a larger amount of data and a higher-density frequency multiplexing technology are used. However, the communication capacity is approaching Shannon's theoretical limit.

Thus, in network design, a scheme for providing an optical fiber cable accommodating a plurality of optical fibers between the same nodes is conceivable to increase the transmission capacity between wavelength division multiplexing transmission equipment. An optical fiber cable accommodates a plurality of optical fibers (for example, hundreds to thousands of optical fibers) within its sheath. Technologies related to the optical network design are disclosed in, for example, Japanese Laid-open Patent Publication No. 2004-312443, Japanese Laid-open Patent Publication No. 2008-54233, Japanese Laid-open Patent Publication No. 2003-224591, Japanese Laid-open Patent Publication No. 2004-336114, and Japanese Laid-open Patent Publication No. 2006-166343.

### SUMMARY

According to an aspect of the invention, an apparatus generates a plurality of communication-route candidates corresponding to a requested communication channel by combining first transmission paths providing connections between particular nodes in a network and second transmission paths providing connections between three or more nodes in the network, where the first transmission paths are accommodated in a plurality of communication cables together with the second transmission paths. The apparatus holds a table indicating first and second association relationships, where the first association relationship associates the first transmission paths with communication cables that accommodate the first transmission paths and are provided at opposite ends of each of the first transmission paths, and the second association relationship associates the second transmission paths with communication cables accommodating the second transmission paths. The apparatus determines, by referring to the table, from among the plurality of communication-route candidates, a communication-route candidate that uses a same communication cable multiple times, and excludes the determined communication-route candidate from the plurality of communication-route candidates.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of a network in which transmission paths and nodes are made redundant;

FIG. 2 is a diagram illustrating an example of a network in which transmission paths are made redundant;

FIG. 3 is a diagram illustrating an example of a network in which transmission paths between particular nodes are made redundant;

FIG. 4 is a diagram illustrating an example of wavelength division multiplexing transmission equipment at general nodes;

FIG. 5 is a diagram illustrating an example of wavelength division multiplexing transmission equipment at local nodes;

FIG. 6 is a diagram illustrating an example of a configuration of a network design apparatus, according to an embodiment;

FIG. 7 is a diagram illustrating an example of a function configuration of a central processing unit (CPU) and information stored in a hard disk drive (HDD), according to an embodiment;

FIG. 8 is a diagram illustrating an example of demand information, according to an embodiment;

FIG. 9 is a diagram illustrating an example of a plurality of communication-route candidates, according to an embodiment;

FIG. 10 is a diagram illustrating an example of a plurality of communication-route candidates, according to an embodiment;

FIG. 11 is a diagram illustrating an example of a network in which transmission paths between particular nodes are made redundant;

FIG. 12 is a diagram illustrating an example of a route conversion table, according to an embodiment;

FIG. 13 is a diagram illustrating an example of conversion of communication-route candidates, according to an embodiment;

FIG. 14 is a diagram illustrating an example of an operational flowchart for a network design method, according to an embodiment; and

FIG. 15 is a diagram illustrating an example of costs for respective network configurations, according to an embodiment.

### DESCRIPTION OF EMBODIMENTS

When an optical fiber cable including a plurality of optical fibers is used to provide connection between adjacent nodes, failures may occur in the plurality of optical fibers when the optical fiber cable is broken, and thus there is a problem in that multiple failures occur in a communication route.

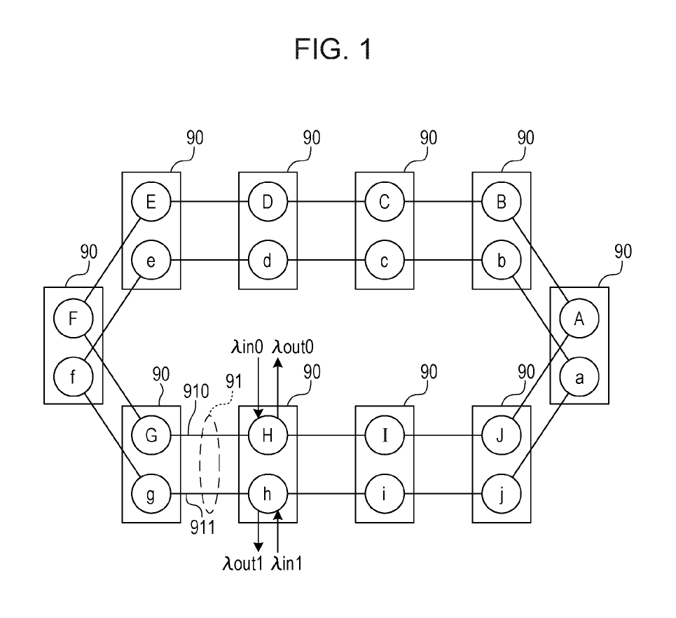

FIG. 1 is a diagram illustrating an example of a network in which transmission paths and nodes are made redundant. This network includes nodes A to J and nodes a to j provided in exchanges 90. Although a case in which a network to be designed is a ring network is described in this example, the embodiment is not limited thereto, and the network may be a network having another architecture, such as a linear or mesh network.

The nodes A to J are connected to each other through first transmission paths 910, and the nodes a to j are connected through second transmission paths 911. Thus, the nodes A to J and the nodes a to j are independent from each other in the network. The first transmission paths 910 and the second transmission paths 911 each include a pair of optical fibers that transmit light in directions opposite to each other. The first transmission paths 910 and the second transmission paths 911 are accommodated in the same optical fiber cables (communication cables) 91.

At the nodes A to J and a to j, respective pieces of wavelength division multiplexing transmission equipment, such as ROADMs, are provided. Each piece of the wavelength division multiplexing transmission equipment at the nodes A to J wavelength-multiplexes an optical signal λin0,input (inserted) from an external network (not illustrated), with another optical signal and transmits the resulting signal to the adjacent node as a multiplexed optical signal. Each piece of the wavelength division multiplexing transmission equipment at the nodes A to J also splits (branches) an optical signal λout0 from a multiplexed optical signal transmitted from the adjacent node and outputs the resulting signals to an external network. Each piece of the wavelength division multiplexing transmission equipment at the nodes a to j also transmits an optical signal λin1, input from an external network, to the adjacent node as a multiplexed optical signal and splits an optical signal λout1 from a multiplexed optical signal transmitted from the adjacent node. A network management apparatus (not illustrated) sets, for the wavelength division multiplexing transmission equipment at the nodes A to J and a to j, the wavelengths of optical signals that are inserted and the wavelengths of optical signals that are branched.

Thus, in the network in this example, a communication channel may be provided between arbitrary nodes (except between the nodes A to J and the nodes a to j). The pieces of wavelength division multiplexing transmission equipment at the nodes A to J are connected to the corresponding first transmission paths 910, and the pieces of wavelength division multiplexing transmission equipment at the nodes a to j are connected to the corresponding second transmission paths 911, thus providing two pathways (that is, transmission paths connected to the adjacent nodes).

In the network in this example, the exchanges 90 are connected to each other through the optical fiber cables 91. Thus, the network has a transmission capacity twice as large as that of a network in which the nodes are not made redundant. However, since the nodes in the exchanges 90 are also made redundant, the equipment cost and the operating cost are also twice as high as those in a network in which the nodes are not made redundant. In the network in this example, since the nodes A to J and the nodes a to j are connected through the individual transmission paths 910 and 911, a requested communication channel is distributed to either of the two transmission paths 910 and 911 in the network design. Thus, when this network is used to provide a communication service, there is the inconvenience that optical signals of customers that receive the communication service provided using the different transmission paths 910 and 911 are not inter-connectable in the form of light without converting the optical signals into electrical signals, since the two sub-networks are independent from each other.

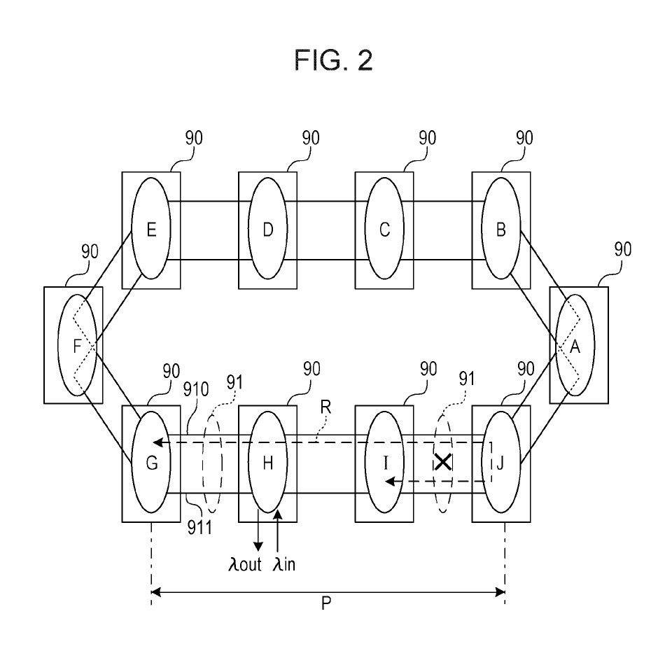

Accordingly, in order to reduce the number of nodes, the nodes A to J and the nodes a to j may be integrated together in the exchanges 90 to configure a network in which the transmission paths are made redundant. FIG. 2 is a diagram illustrating an example of a network in which transmission paths are made redundant. In FIG. 2, elements that are the same as or similar to those in FIG. 1 are denoted by the same reference numerals, and descriptions thereof are not given hereinafter.

In the network in this example, exchanges 90 are provided with respective nodes A to J. The nodes A to J are connected to each other through first transmission paths 910 and second transmission paths 911. Thus, each piece of the wavelength division multiplexing transmission equipment provided in the nodes A to J has four pathways.

In this example network, although the number of nodes in each exchange 90 is reduced to one, the number of pathways at each piece of wavelength division multiplexing transmission equipment increases, and thus cost is not reduced sufficiently. In addition, since each of the nodes A to J is connected to both the first transmission paths 910 and the second transmission paths 911, a single network is formed. Thus, in this network, the inconvenience related to the interconnection described above with reference to FIG. 1 does not occur.

However, since two candidate transmission paths 910 and 911 exist for each of the nodes A to J, design of a communication route for a communication channel is complicated. For example, when a communication channel P is requested between the nodes G and J, the number of communication-route candidates for the communication channel P is 8 (=2×2×2), since two candidate transmission paths exist between the nodes G and H, two between the nodes H and I, and two between the nodes I and J. Hence, it is desired that the communication route design be simplified.

Also, in the networks illustrated in FIGS. 1 and 2, the nodes A to J and the nodes a to j are connected to each other through the optical fiber cables 91 accommodating the plurality of optical fibers. Thus, for example, when any of the optical fiber cables 91 is broken, failures may occur in the plurality of the optical fibers therein at the same time. When failures occur in the plurality of optical fibers at the same time, a problem arises in that the multiple failures make it difficult to re-establish communication channels.

For example, in FIG. 2, when the optical fiber cable 91 between the node I and the node J is broken (see mark x), failures occur in both of the first transmission path 910 and the second transmission path 911 in the section. In this case, multiple failures occur in a communication route R that originates at the node G, turns back at the node J, and reaches the node I. Thus, it is desirable that the network using the optical fiber cables 91 be designed so as to avoid multiple failures.

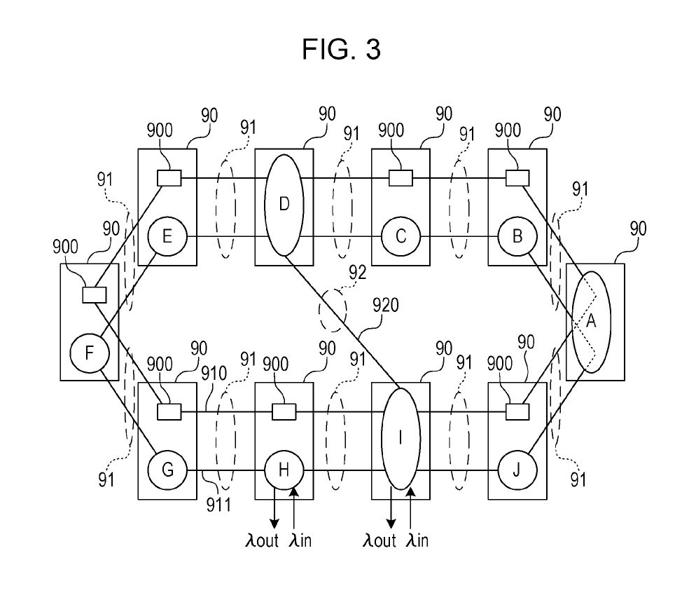

FIG. 3 is a diagram illustrating an example of a network in which transmission paths between particular nodes are made redundant. In FIG. 3, elements that are the same as or similar to those in FIG. 1 are denoted by the same reference numerals, and descriptions thereof are not given hereinafter.

In the network in this example, only particular nodes A, D, and I are connected to first transmission paths 910, and other nodes B, C, E to H, and J are connected to only second transmission paths 911. In exchanges in which the nodes B, C, E to H, and J are provided, the first transmission paths 910 are coupled to each other via optical connectors 900. The first transmission paths 910 may also be coupled to each other via optical amplifiers, instead of the optical connectors 900.

According to this configuration, the second transmission paths 911 provide connections between all (three or more) the nodes A to J in the network, and the first transmission paths 910 provide connections between the particular nodes A, D, and I in the network. This makes it easier to selectively use the first transmission paths 910 and the second transmission paths 911, thus simplifying the design of communication routes. When this network is compared to a railroad, the first transmission paths 910 correspond to local lines, and the second transmission paths 911 correspond to express lines. The particular nodes A, D, and I correspond to express train stations, and the other nodes B, C, E to H, and J correspond to regular stations. In the following description, the nodes A, D, and I are referred to as “general nodes”, and the nodes B, C, E to H, and J are referred to as “local nodes”. Also, the first transmission paths 910 are referred to as “sub transmission paths”, and the second transmission paths 911 are referred to as “main transmission paths”.

The nodes D and I are also directly connected to each other through an auxiliary transmission path 920. The auxiliary transmission path 920 is accommodated in an optical fiber cable 92 that is different from the optical fiber cables 91 accommodating the first transmission paths 910 and the second transmission paths 911. Since the auxiliary transmission path 920 is logically the same as the sub transmission paths 910 between the nodes D and I, only the sub transmission paths 910 may be used for communication routes.

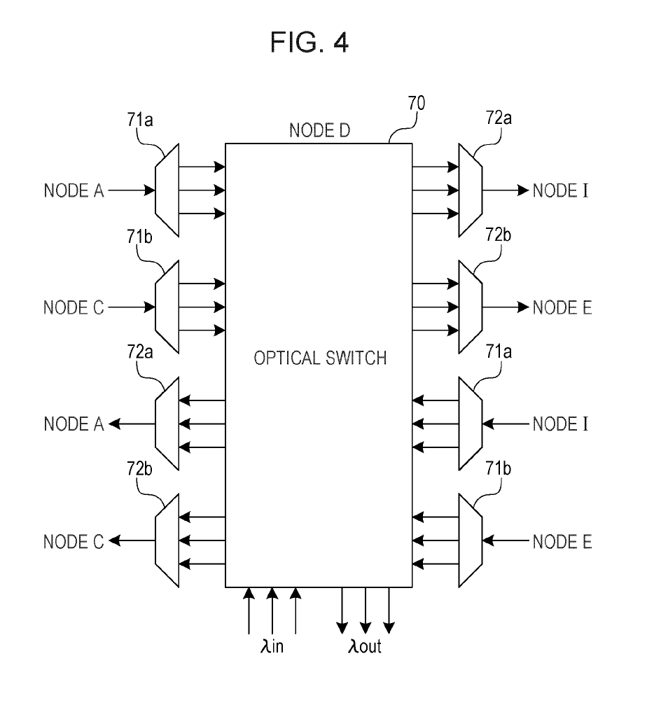

FIG. 4 is a diagram illustrating an example of the wavelength division multiplexing transmission equipment at the general nodes A, D, and I. Although FIG. 4 illustrates the configuration of the wavelength division multiplexing transmission equipment at the general node D, the configurations of the wavelength division multiplexing transmission equipment at the other general nodes A and I are also substantially the same. In FIG. 4, elements related to the auxiliary transmission path 920 are not illustrated.

The wavelength division multiplexing transmission equipment has four multiplexers 72a and 72b, four demultiplexers 71a and 71b, and an optical switch 70. Each of the demultiplexers 71a and 71b demultiplexes an input multiplexed optical signal by splitting optical signals with different wavelengths and outputs the resulting optical signals to the optical switch 70. The demultiplexers 71a are connected to the corresponding adjacent general nodes A and I through the sub transmission paths 910, and the demultiplexers 71b are connected to the corresponding adjacent local nodes C and E through the main transmission paths 911.

The optical switch 70 switches between destinations to which optical signals are to be output. The optical switch 70 outputs multiplexed optical signals, input from the demultiplexers 71a and 71b, or optical signals λin, input from an external network, to the multiplexers 72a and 72b corresponding to the pathways to which the optical signals are to be output. The optical switch 70 also outputs only optical signals λout to be branched to an external network, the optical signals being included in optical signals split according to the wavelengths by the demultiplexers 71a and 71b.

Each of the multiplexers 72a and 72b multiplexes optical signals with different wavelengths. Each of the multiplexers 72a and 72b multiplexes optical signals input from the optical switch 70 to generate a multiplexed optical signal and outputs the multiplexed optical signal. The multiplexers 72a are connected to the corresponding adjacent general nodes I and A through the sub transmission paths 910, and the multiplexers 72b are connected to the corresponding adjacent local nodes E and C through the main transmission paths 911.

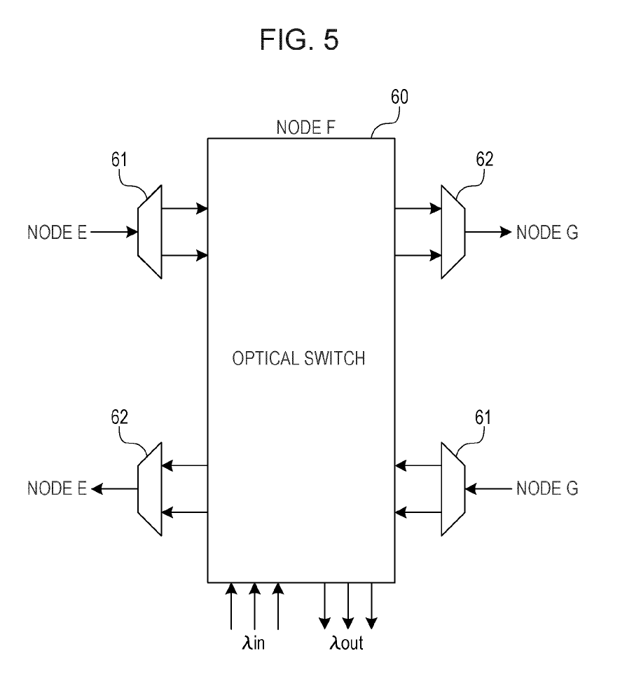

FIG. 5 is a diagram illustrating an example of the wavelength division multiplexing transmission equipment at the local nodes B, C, E to H, and J. Although FIG. 5 illustrates the configuration of the wavelength division multiplexing transmission equipment at the local node F, the configurations of the wavelength division multiplexing transmission equipment at the other local nodes B, C, E, G, H, and J are also substantially the same.

The wavelength division multiplexing transmission equipment has two multiplexers 62, two demultiplexers 61, and an optical switch 60. Each demultiplexer 61 demultiplexes an input multiplexed optical signal by splitting optical signals with different wavelengths and outputs the resulting optical signals to the optical switch 60. The demultiplexers 61 are connected to the corresponding adjacent local nodes E and G through the main transmission paths 911.

The optical switch 60 switches between destinations to which optical signals are to be output. The optical switch 60 outputs multiplexed optical signals, input from the demultiplexers 61, or optical signals λin, input from an external network, to the multiplexers 62 corresponding to the pathways to which the optical signals are to be output. The optical switch 60 also outputs only optical signals λout to be branched to an external network, the optical signals being included in optical signals split according to the wavelengths by the demultiplexers 61.

Each multiplexer 62 multiplexes optical signals with different wavelengths. Each multiplexer 62 multiplexes optical signals input from the optical switch 60 to generate a multiplexed optical signal and outputs the multiplexed optical signal. The multiplexers 62 are connected to the corresponding adjacent local nodes E and G through the main transmission paths 911.

As described above, the number of pathways at each piece of the wavelength division multiplexing transmission equipment at the general nodes A, D, and I is 4 and the number of pathways at each piece of the wavelength division multiplexing transmission equipment at the local nodes B, C, E to H, and J is 2. Thus, the total number of multiplexers 72a and 72b and demultiplexers 71a and 71b in each piece of the wavelength division multiplexing transmission equipment at the general nodes A, D, and I is 8, and the total number of multiplexers 62 and demultiplexers 61 in the wavelength division multiplexing transmission equipment at the local nodes B, C, E to H, and J is 4.

Hence, the general nodes A, D, and I have a larger number of optical components than the local nodes B, C, E to H, and J, and thus involve a higher equipment cost than that of the local nodes B, C, E to H, and J. However, in the network illustrated in FIG. 3, since the general nodes A, D, and I are particular nodes, not all of the nodes, the equipment cost is reduced compared with the network in FIG. 2 in which all of the nodes are general nodes. For example, in order to design the network illustrated in FIG. 3, a network design apparatus according to the embodiment performs communication-route design and wavelength assignment for each requested communication channel.

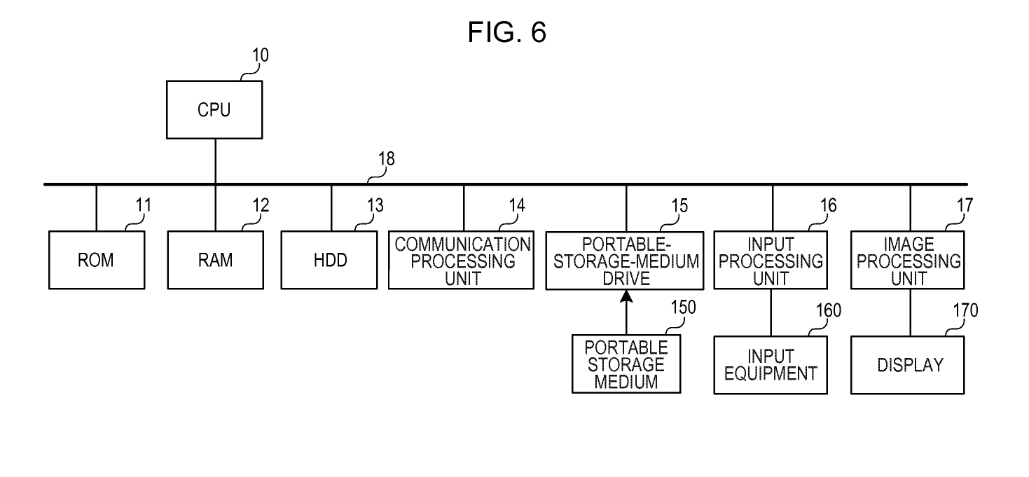

FIG. 6 is a diagram illustrating an example of a configuration of a network design apparatus, according to an embodiment. The network design apparatus is, for example, a computer apparatus such as a server. The network design apparatus includes a CPU 10, a read only memory (ROM) 11, a random access memory (RAM) 12, an HDD (a storage unit) 13, a communication processing unit 14, a portable-storage-medium drive 15, an input processing unit 16, and an image processing unit 17.

The CPU 10 is a computational processor and performs network design processing in accordance with a network design program. The CPU 10 is communicably connected to the aforementioned elements 11 to 17 through a bus 18. The network design apparatus 1 is not limited to an apparatus that operates on software. The CPU 10 may also be replaced with other hardware, such as an integrated circuit for a specific application.

The RAM 12 is used as a working memory for the CPU 10. The ROM 11 and the HDD 13 are used to store therein, for example, the network design program, which causes the CPU 10 to operate. The communication processing unit 14 is, for example, a network card and communicates with external apparatuses and equipment through a network, such as a local area network (LAN).

The portable-storage-medium drive 15 is equipment that writes information to and reads information from a portable storage medium 150. Examples of the portable storage medium 150 include a Universal Serial Bus (USB) memory, a recordable compact disc (CD-R), and a memory card. The network design program may also be stored in/on the portable storage medium 150.

The network design apparatus further has input equipment 160 for performing an operation for inputting information and a display 170 for displaying images. The input equipment 160 includes, for example, a keyboard, a mouse, and so on. Information input using the input equipment 160 is output to the CPU 10 via the input processing unit 16. The display 170 is, for example, a liquid-crystal display that displays images. Image data from the CPU 10 is output and displayed on the display 170 via the image processing unit 17. The input equipment 160 and the display 170 may also be replaced with equipment, such as a touch panel having those functions.

The CPU 10 executes programs stored in the ROM 11, the HDD 13, or the like or programs read from the portable storage medium 150 by the portable-storage-medium drive 15. The programs include not only an operating system (OS) but also the aforementioned network design program. The programs may also include a program downloaded via the communication processing unit 14 or a program stored in the portable storage medium 150.

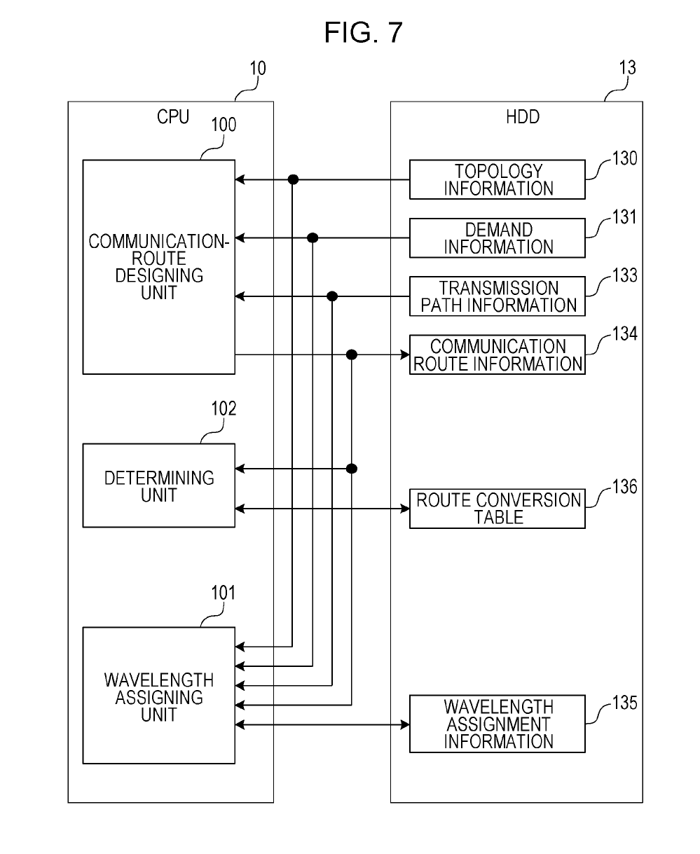

Upon executing the network design program, the CPU 10 realizes multiple functions. FIG. 7 is a diagram illustrating an example of the functions of the CPU 10 and information stored in the HDD 13, according to an embodiment.

The CPU 10 includes a communication-route designing unit 100, a determining unit 102, and a wavelength assigning unit 101. The HDD 13 also stores therein topology information 130, demand information 131, transmission path information 133, communication route information 134, a route conversion table (table) 136, and wavelength assignment information 135 in connection with the communication-route designing unit 100, the determining unit 102, and the wavelength assigning unit 101. The storage of the information 130 to 135 and the route conversion table 136 is not limited to the HDD 13 and may also be the ROM 11 or the portable storage medium 150.

The topology information 130, the demand information 131, and the transmission path information 133 are design information indicating conditions for designing the network. For example, the topology information 130, the demand information 131, and the transmission path information 133 may be input via the input equipment 160 by an operator or may also be downloaded from a network via the communication processing unit 14.

The topology information 130 indicates a topology of a network (see FIG. 3) to be designed, that is, the relationship of connections of the nodes A to J through links. The topology information 130 is composed, for example, by associating identifiers of a pair of nodes connected through each link in the network with an identifier of the link.

The demand information 131 indicates the contents of requests for communication channels to be established in the network. The demand information 131 includes, for example, information identifying a pair of nodes serving as termination points (a start point and an end point) of each communication channel, and the number of wavelengths used for the communication channels. Each pair of nodes that serve as the termination points of a communication channel is a combination of a node to which an optical signal λin is inserted and a node at which an optical signal λout is branched.

The transmission path information 133 indicates the configuration of transmission paths that provide connections between the nodes A to J in the network. The transmission path information 133 is composed by associating the number of optical fibers with a pair of nodes that serve as termination points with respect to each of the main transmission paths 911 that provide connections between all (three or more) the nodes A to J and each of the sub transmission paths 910 that provide connections between the general nodes A, D, and I.

The route conversion table 136 indicates association relationship between the main transmission paths 911 and the optical fiber cables 91 accommodating the main transmission paths 911, and association relationship between sub transmission paths 910 and the optical fiber cables 91 that accommodate the sub transmission paths 910 and are provided at opposite ends of each of the sub transmission paths 910. More specifically, the main transmission paths 911 and the sub transmission paths 910 are registered in the route conversion table 136 in association with identifiers of the optical fiber cables 91. The determining unit 102 refers to the route conversion table 136 to determine a communication-route candidate that uses the same optical fiber cable 91 multiple times.

The communication-route designing unit 100 reads the topology information 130, the demand information 131, and the transmission path information 133 and combines the main transmission path(s) 911, the sub transmission path(s) 910, and the auxiliary transmission path 920 to generate a plurality of communication-route candidates corresponding to a requested communication channel. The generated plurality of communication-route candidates are written to the HDD 13 as the communication route information 134. The communication route information 134 includes, for example, a combination of identifiers of the main transmission path(s) 911, the sub transmission path(s) 910, and the auxiliary transmission path 920 in each communication route.

By referring to the route conversion table 136, the determining unit 102 determines, from among the plurality of communication-route candidates, a communication-route candidate that uses the same optical fiber cable 91 multiple times and excludes the determined communication-route candidate from the plurality of communication-route candidates. In this case, the determining unit 102 determines a communication-route candidate that uses the optical fiber cable 91 multiple times, by converting information on the main transmission path(s) 911 and the sub transmission path(s) 910 included in each of the plurality of communication-route candidates into identifiers. After the determining unit 102 performs the determination processing, the communication-route designing unit 100 determines, among the remaining communication-route candidates, a communication route for the communication channel.

The wavelength assigning unit 101 also reads the topology information 130, the demand information 131, the transmission path information 133, and the communication route information 134, and assigns, for each communication channel, wavelengths included in a wavelength multiplexing optical signal. The wavelength assigning unit 101 assigns mutually different wavelengths to respective communication channels that use the same transmission path 910, 911, or 920 in the communication routes. The wavelength assigning unit 101 generates wavelength assignment information 135 indicating wavelengths for the corresponding requested communication channels as an assignment result and writes the wavelength assignment information 135 to the HDD 13. Design processing performed by the network design apparatus will be described below in detail.

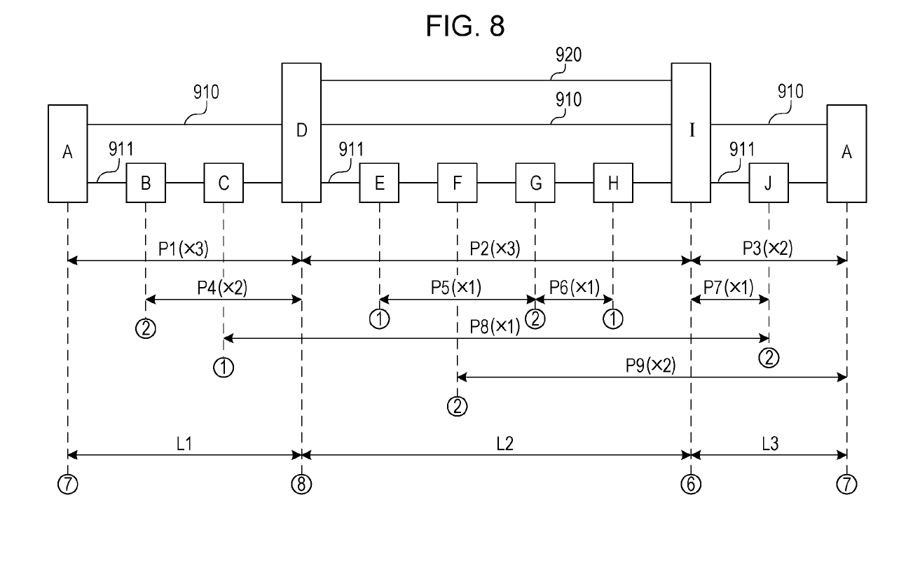

FIG. 8 is a diagram illustrating an example of the contents of the demand information 131. FIG. 8 illustrates a linearly expanded form of the network illustrated in FIG. 3. In this example, the upper limit of the number of wavelengths assignable to each transmission path is assumed to be 4.

A communication channel P1 is requested between the nodes A and D, and the number of wavelengths is 3 (see “×3” in the parentheses, which notation also applies to the following). A communication channel P2 is requested between the nodes D and I, and the number of wavelengths is 3. A communication channel P3 is requested between the nodes I and A, and the number of wavelengths is 2. A communication channel P4 is requested between the nodes B and D, and the number of wavelengths is 2. A communication channel P5 is requested between the nodes E and G, and the number of wavelengths is 1.

A communication channel P6 is requested between the nodes G and H, and the number of wavelengths is 1. A communication channel P7 is requested between the nodes I and J, and the number of wavelengths is 1. A communication channel P8 is requested between the nodes C and J, and the number of wavelengths is 1. A communication channel P9 is requested between the nodes F and A, and the number of wavelengths is 2.

In FIG. 8, each numeral indicated in a circle represents the total number of optical signals λin and λout inserted into or branched at a corresponding one of the nodes A to J. For example, in the case of the node A, since three optical signals of the communication channel P1, two optical signals of the communication channel P3, and two optical signals of the communication channel P9 are inserted or branched, the total number of optical signals λin and λout is 7. Also, in the case of the node G, since an optical signal of the communication channel P5 and an optical signal of the communication channel P6 are inserted or branched, the total number of optical signals λin and λout is 2.

In this example, the nodes A, D, and I at which the total number of optical signals λin and λout is 5 or more are referred to as general nodes, and the nodes B, C, E to H, and J at which the total number of optical signals λin and λout is 4 or less are referred to as local nodes. Thus, by determining the general nodes and the local nodes depending on the total number of optical signals λin and λout in accordance with the demand information 131, the communication-route designing unit 100 can efficiently design communication routes for the communication channels P1 to P9.

That is, since each general node is connected to both of the main transmission paths 911 and the sub transmission paths 910, the number of candidates of routes of the optical signals λin and λout is larger than that of the local node. This makes it possible to flexibly provide a communication route. When the largest number of wavelengths of optical signals transmitted to the main transmission path 911 and the sub transmission path 910 is assumed to be 4, the total number of optical signals λin and λout at each of the general nodes A, D, and I exceeds 4. Thus, the optical signals λin and λout are separately transmitted to the main transmission path 911 and the sub transmission path 910.

The communication-route designing unit 100 divides the communication channels P1 to P9 indicated by the demand information 131 into two groups, depending upon whether or not the sub transmission paths 910 are usable. More specifically, the communication-route designing unit 100 determines whether or not any of links L1 to L3 that provide connections between the general nodes exist in each of the sections of the communication channels P1 to P9, and divides the communication channels P1 to P9 into two groups in accordance with the result of the determination. The link L1 is a link between the general nodes A and D, the link L2 is a link between the general nodes D and I, and the link L3 is a link between the general nodes A and I.

In this example, the link L1 exists in the section of the communication channel P1 (between the nodes A and D), the link L2 exists in the sections of the communication channel P2 (between the nodes D and I) and the communication channel P8 (between the nodes C and J), and the link L3 exists in the sections of the communication channel P3 (between the nodes A and I) and the communication channel P9 (between the nodes A and F). Thus, the communication channels P1 to P3, P8, and P9 belong to the group that is allowed to use the sub transmission paths 910, and the other communication channels P4 to P7 belong to the group that is not allowed to use the sub transmission paths 910.

With respect to the group that is allowed to use the sub transmission paths 910, the communication-route designing unit 100 designs communication routes including the sub transmission paths 910. For example, the communication-route designing unit 100 selects a combination of the sub transmission path 910 between the general nodes D and I, the main transmission path 911 between the local nodes C and D, and the main transmission path 911 between the local nodes I and J as a communication route for the communication channel P8.

With respect to the group that is not allowed to use the sub transmission paths 910, the communication-route designing unit 100 designs a communication route including only the main transmission path(s) 911. For example, the communication-route designing unit 100 selects a combination of the main transmission path 911 between the local nodes E and F and the main transmission path 911 between the local nodes F and G as a communication route for the communication channel P5.

The communication-route designing unit 100 determines a communication route from among the generated plurality of communication-route candidates. In this case, as described above with reference to FIG. 2, in order to prevent occurrence of multiple failures, the determining unit 102 determines a communication-route candidate that uses the same optical fiber cable multiple times and excludes the determined communication-route candidate from the plurality of communication-route candidates. Details of design of communication routes will be described below.

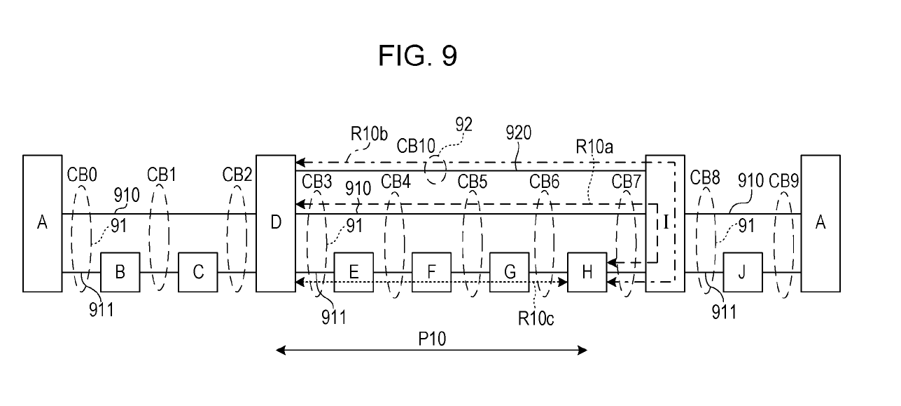

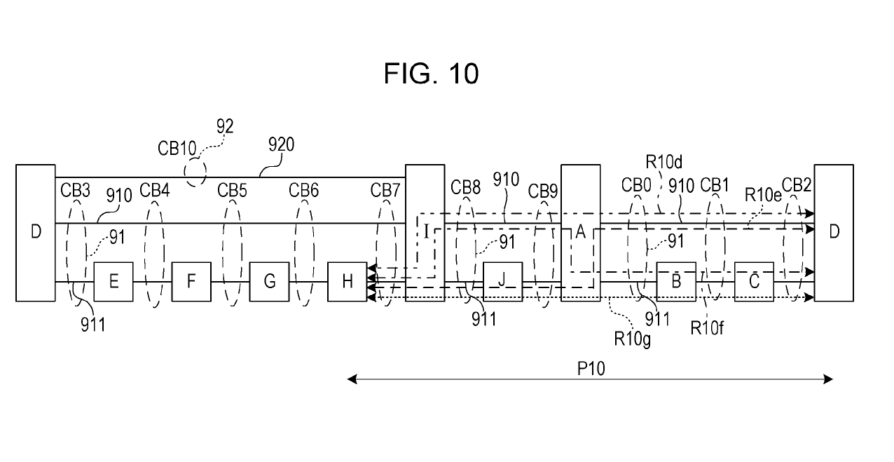

FIGS. 9 and 10 are diagrams illustrating an example of a plurality of communication-route candidates, according to an embodiment. More specifically, FIG. 9 illustrates, among a plurality of communication-route candidates generated when a communication channel P10 is requested between the nodes D and H, communication-route candidates R10a to R10c that do not pass through the node A. FIG. 10 illustrates, among the plurality of communication-route candidates generated when the communication channel P10 is requested between the nodes D and H, communication-route candidates R10d to R10g that pass through the node A. In FIGS. 9 and 10, “CB0” to “CB9” represent the identifiers of the optical fiber cables 91, and “CB10” represents the identifier of the optical fiber cable 92.

The communication route R10a is a combination of the sub transmission path 910 between the nodes D and I and the main transmission path 911 between the nodes I and H, and is provided so as to originate at the node D, turn back at the node I, and reach the node H. Thus, since the communication route R10a uses the same optical fiber cable 91 (CB7) between the nodes I and H multiple times, the determining unit 102 excludes the communication route R10a from the plurality of communication-route candidates. If the communication route R10a is used for a communication channel, when the optical fiber cable 91 between the nodes I and H is broken, failures may occur in the main transmission paths 911 and the sub transmission path 910 at the same time.

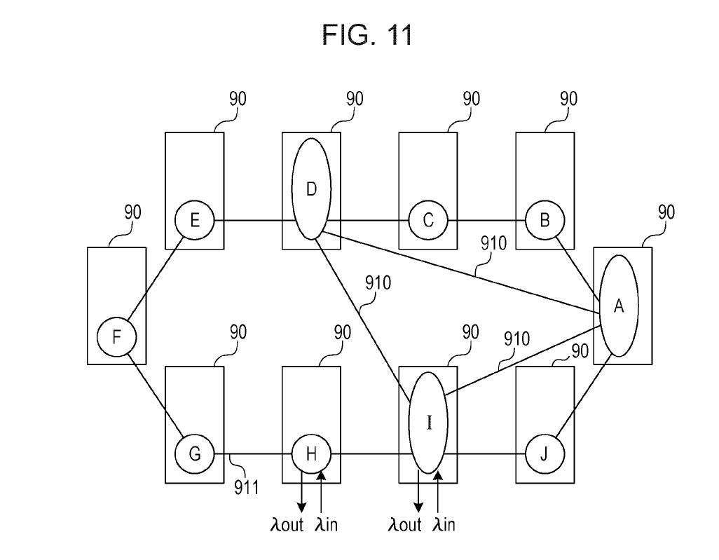

However, when the optical fibers of the main transmission paths 911 and the sub transmission paths 910 are not accommodated in the common optical fiber cables 91, a turn-back communication route, such as the communication route R10a, may not be excluded from the plurality of communication-route candidates. FIG. 11 is a diagram illustrating an example of a network in which transmission paths between particular nodes are made redundant.

The network in this example is logically the same as the example network illustrated in FIG. 3. However, since main transmission paths 911 and sub transmission paths 910 are respectively accommodated in individual optical fiber cables, it is possible to use a turn-back communication route without occurrence of multiple failures. However, since the number of optical fiber cables used is larger than that in the network illustrated in FIG. 3, the installation cost of the optical fiber cables also increases.

Referring back to FIG. 9, the communication route R10b is a combination of the auxiliary transmission path 920 between the nodes D and I and the main transmission path 911 between nodes I and H, and is provided so as to originate at the node D, turn back at the node I, and reach the node H. However, since the optical fiber cable 92 (CB10), which accommodates the auxiliary transmission path 920, and the optical fiber cables 91 (CB3 to CB7), which accommodate the main transmission paths 911, are different from each other, the communication route R10b does not use the same optical fiber cable 91 multiple times. Thus, the determining unit 102 does not exclude the communication route R10b from the plurality of communication-route candidates.

The communication route R10c is a combination of the main transmission path 911 between the nodes D and E, the main transmission path 911 between the nodes E and F, the main transmission path 911 between the nodes F and G, and the main transmission path 911 between the nodes G and H. In the case of the communication route R10c, since the transmission paths 911 therein are accommodated in the optical fiber cables 91 (CB3 to CB6) that are different from each other, the determining unit 102 does not exclude the communication route R10c from the plurality of communication-route candidates.

Referring to FIG. 10, the communication route R10d is a combination of the sub transmission path 910 between the nodes D and A, the sub transmission path 910 between the nodes A and I, and the main transmission path 911 between the nodes I and H. In the case of the communication route R10d, since the transmission paths 910 and 911 therein are accommodated in the optical fiber cables 91 (CB0 to CB2 and CB7 to CB9) that are different from each other, the determining unit 102 does not exclude the communication route R10d from the plurality of communication-route candidates.

The communication route R10e is a combination of the sub transmission path 910 between the nodes D and A, the main transmission path 911 between the nodes A and J, the main transmission path 911 between the nodes J and I, and the main transmission path 911 between the nodes I and H. In the case of the communication route R10e, since the transmission paths 910 and 911 therein are accommodated in the optical fiber cables 91 (CB0 to CB2 and CB7 to CB9) that are different from each other, the determining unit 102 does not exclude the communication route R10e from the plurality of communication-route candidates.

The communication route R1Of is a combination of the sub transmission path 910 between the nodes A and I, the main transmission paths 911 between the nodes D and C, the main transmission paths 911 between the nodes C and B, the main transmission paths 911 between the nodes B and A, and the main transmission paths 911 between the nodes I and H. In the case of the communication route R10f, since the transmission paths 910 and 911 therein are accommodated in the optical fiber cables 91 (CB0 to CB2, CB7 to CB9) that are different from each other, the determining unit 102 does not exclude the communication route R10f from the plurality of communication-route candidates.

The communication route R10g is a combination of the main transmission path 911 between the nodes D and C, the main transmission path 911 between the nodes C and B, the main transmission path 911 between the nodes B and A, the main transmission path 911 between the nodes A and J, the main transmission path 911 between the nodes J and I, and the main transmission path 911 between the nodes H and I. In the case of the communication route R10g, the transmission paths 911 therein are accommodated in the optical fiber cables 91 (CB0 to CB2 and CB7 to CB9) that are different from each other, the determining unit 102 does not exclude the communication route R10g from the plurality of communication-route candidates.

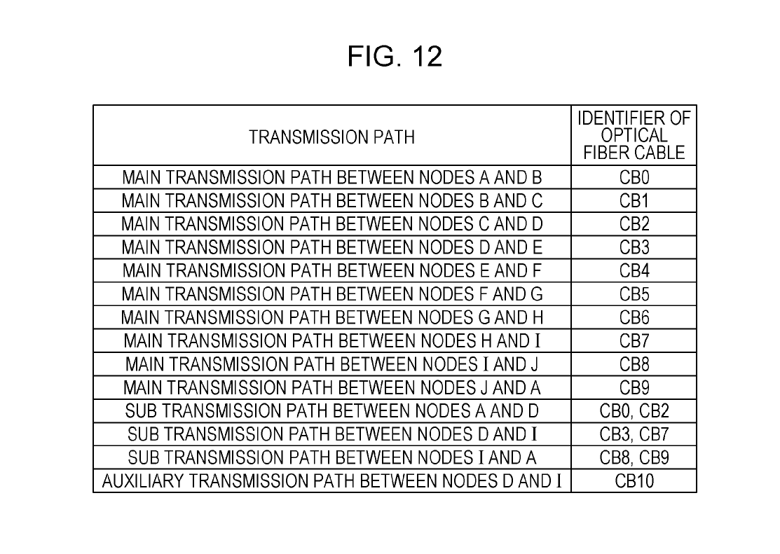

By using the route conversion table 136, the determining unit 102 converts information on the transmission paths 910, 911, and 920, included in the plurality of communication-route candidates, into identifiers of the optical fiber cables 91 and 92 accommodating the transmission paths 910, 911, and 920. FIG. 12 is a diagram illustrating an example of contents of a route conversion table 136, according to an embodiment. In FIG. 12, “transmission path” indicate the transmission paths 910, 911, and 920 illustrated in FIGS. 9 and 10, and “identifier of optical fiber cable” indicate the identifiers “CB0” to “CB10” of the optical fiber cables 91 and 92.

The route conversion table 136 indicates association relationships between the main transmission paths 911 and the optical fiber cables 91 accommodating the main transmission paths 911. For example, the main transmission path 911 between the nodes A and B is registered in association with the identifier “CB0” of the optical fiber cable 91 accommodating the main transmission path 911. The main transmission path 911 between the nodes B and C is registered in association with the identifier “CB1” of the optical fiber cable 91 accommodating the main transmission path 911.

The route conversion table 136 also indicates association relationships between the sub transmission paths 910 and the optical fiber cables 91 that accommodate the sub transmission paths 910 and are provided at opposite ends of each of the sub transmission paths 910. For example, the sub transmission path 910 between the nodes A and D is registered in association with, among the optical fiber cables 91 (see “CB0” to “CB2”) accommodating the sub transmission path 910, the identifiers “CB0” and “CB2” of the optical fiber cables 91 provided at opposite ends of sub transmission path 910. The sub transmission path 910 between the nodes D and I is registered in association with, among the optical fiber cable 91 (see “CB3” to “CB7”) accommodating the sub transmission path 910, the identifiers “CB3” and “CB7” of the optical fiber cable 91 provided at opposite ends of the sub transmission path 910.

Since only the identifiers of the optical fiber cables 91 provided at the opposite ends, not all of the optical fiber cables 91 accommodating the sub transmission paths 910, are registered in the route conversion table 136, as described above, an increase in the amount of data in the HDD 13 is suppressed.

The route conversion table 136 further indicates association relationships between the auxiliary transmission path 920 and the optical fiber cable 92 accommodating the auxiliary transmission path 920. Thus, the auxiliary transmission path 920 between the nodes D and I is registered in association with the identifier “CB10” of the optical fiber cable 92 accommodating the auxiliary transmission path 920.

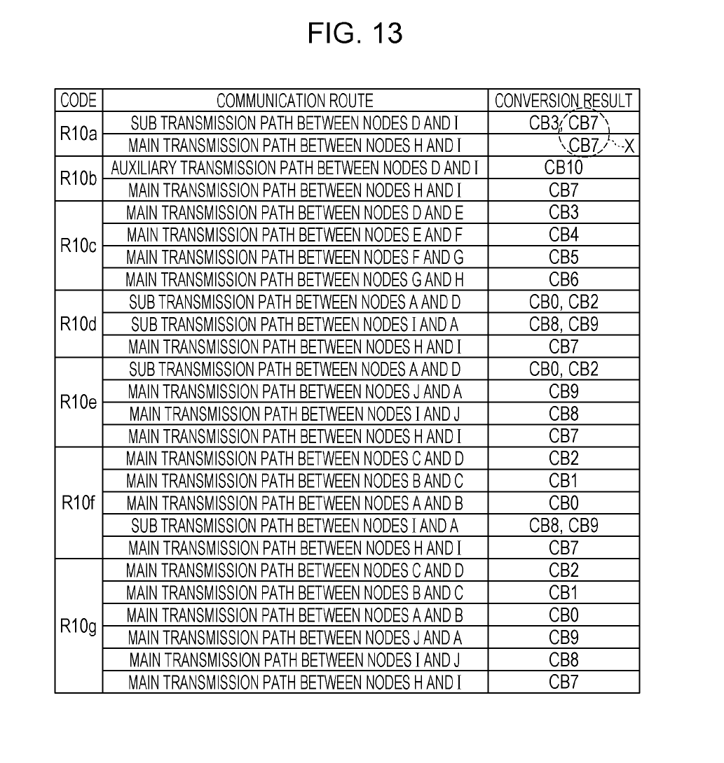

By referring to the route conversion table 136, the determining unit 102 converts information on the main transmission path(s) 911, the sub transmission path(s) 910, and the auxiliary transmission path 920 included in each of the plurality of communication-route candidates into a set of identifiers, and determines a communication-route candidate having overlapping identifiers, that is, a communication-route candidate for which the converted set of identifiers includes multiple identifiers having the same value. FIG. 13 is a diagram illustrating an example of communication-route candidates and a result of the conversion, according to an embodiment. In FIG. 13, “code” indicates the codes of the communication routes R10a to R10g in FIGS. 9 and 10, and “communication route” indicates the transmission paths 910, 911, and 920 included in the communication routes R10a to R10g in FIGS. 9 and 10. Also, “conversion result” indicates a result obtained by converting the transmission paths 910, 911, and 920 included in the communication routes R10a to R10g into the identifiers “CB0” to “CB10” by using the route conversion table 136 (see FIG. 12).

For example, the communication route R10b is a combination of the auxiliary transmission path 920 between the nodes D and I and the main transmission path 911 between the nodes H and I. Information on the auxiliary transmission path 920 between the nodes D and I is conversed into the identifier “CB10” in accordance with the route conversion table 136, and information on the main transmission path 911 between the nodes H and I is conversed into the identifier “CB7” in accordance with the route conversion table 136. Thus, the determining unit 102 recognizes the communication route R10b as a set of the identifiers “CB10” and “CB7”.

The communication route R10d is a combination of the sub transmission paths 910 between the nodes A and D and between the nodes I and A and the main transmission path 911 between the nodes H and I. Information on the sub transmission path 910 between the nodes A and D is converted into the identifiers “CB0” and “CB2” in accordance with the route conversion table 136, and information on the sub transmission path 910 between the nodes I and A is conversed into the identifiers “CB8” and “CB9” in accordance with the route conversion table 136. Information on the main transmission path 911 between the nodes H and I is also conversed into the identifier “CB7” in accordance with the route conversion table 136. Thus, the determining unit 102 recognizes the communication route R10d as a set of the identifiers “CB0”, “CB2”, and “CB7” to “CB9”.

Since the result of the conversion indicate that each of the communication routes R10b and 10d does not have overlapping identifiers, the determining unit 102 does not exclude the communication routes R10b and R10d from the plurality of communication-route candidates. This is also true for communication routes R10c and R10e to R10g.

On the other hand, the communication route R10a is a combination of the sub transmission path 910 between the nodes D and I and the main transmission path 911 between the nodes H and I. Information on the sub transmission path 910 between the nodes D and I is converted into the identifiers “CB3” and “CB7” in accordance with the route conversion table 136, and information on the main transmission path 911 between nodes H and I is converted into the identifier “CB7” in accordance with the route conversion table 136. Thus, the determining unit 102 recognizes the communication route R10b as a set of the identifiers “CB3”, “CB7”, and “CB7”.

Since the result of the conversion indicates that the communication route R10a has the overlapping identifiers “CB7” (see character X), the determining unit 102 excludes the communication route R10a from the plurality of communication-route candidates. The excluded communication route R10a is deleted from the communication route information 134. Thus, the communication-route designing unit 100 determines, from among the communication routes R10b to R10g except the communication route R10a, a communication route for a communication channel. Accordingly, the network design apparatus according to the embodiment makes it possible to design a network in which multiple failures are avoided.

Since the determining unit 102 uses, as described above, the identifiers “CB0” to “CB10” of the optical fiber cables 91 to determine a communication-route candidate that uses the optical fiber cable 91 multiple times, it is easy to perform the determination processing.

In addition, although each of the sub transmission paths 910 is accommodated in the plurality of optical fiber cables 91, only the identifiers of the optical fiber cables 91 provided at opposite ends are registered in the route conversion table 136. This reduces the number of identifiers that are to be subjected to the determination processing performed by the determining unit 102. Thus, the determining unit 102 may determine a communication-route candidate that uses the same optical fiber cable 91 multiple times in a shorter time than that in a case in which the identifiers of all of the optical fiber cables 91 accommodating the sub transmission paths 910 are registered in the route conversion table 136.

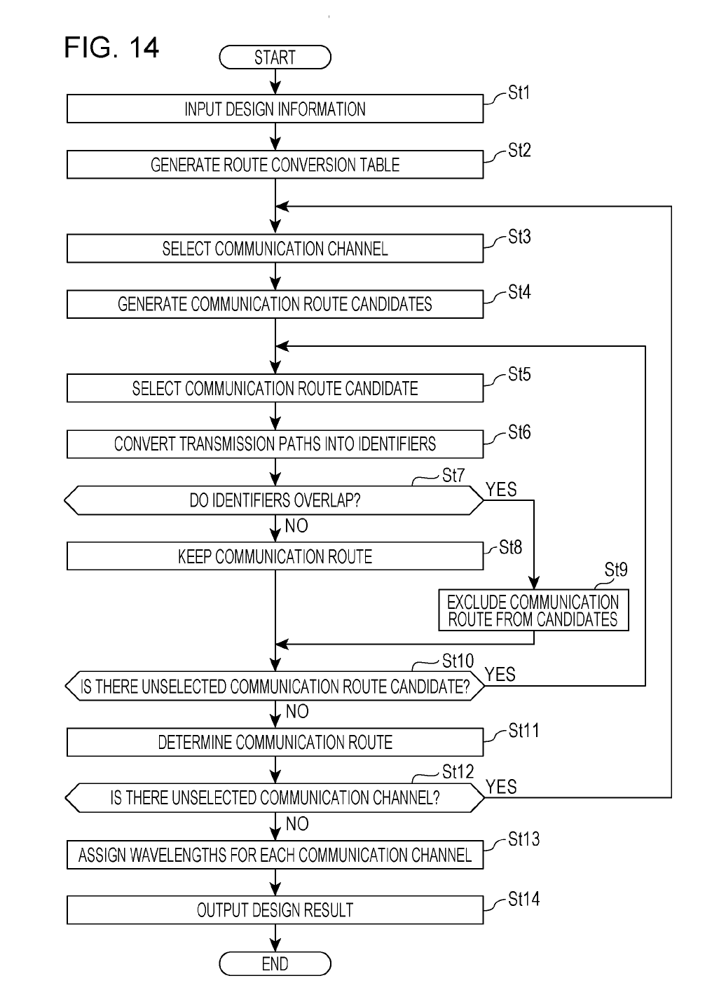

Next, a description will be given of the operation of the network design apparatus. FIG. 14 is a diagram illustrating an example of an operational flowchart for a network design method, according to an embodiment.

First, in step St1, an operator inputs design information to the network design apparatus via the input equipment 160 or the communication processing unit 14. The design information includes the topology information 130, the demand information 131, and the transmission path information 133. The design information is stored in the HDD 13.

Next, in step St2, based on the topology information 130 and the transmission path information 133, the communication-route designing unit 100 generates a route conversion table 136. As described above, the main transmission paths 911, the sub transmission paths 910, and the auxiliary transmission path 920 are registered in the route conversion table 136 in association with the identifiers “CB0” to “CB10” of the optical fiber cables 91 and 92.

In step St3, the communication-route designing unit 100 selects one of requested communication channels, based on the demand information 131. Next, in step St4, based on the topology information 130, the demand information 131, and the transmission path information 133, the communication-route designing unit 100 combines the transmission paths 910, 911, and 920 to thereby generate a plurality of communication-route candidates corresponding to the selected communication channel. The communication-route designing unit 100 writes information on the generated plurality of communication-route candidates to the HDD 13 as the communication route information 134.

Next, in step St5, the determining unit 102 selects one of the plurality of communication-route candidates. Next, in step St6, by referring to the route conversion table 136, the determining unit 102 converts information on the main transmission path(s) 911, the sub transmission path(s) 910, and the auxiliary transmission path 920 included in the selected communication-route candidate into a set of corresponding identifiers “CB0” to “CB10”. The method for the conversion is analogous to the method described above with reference to FIG. 13.

In step St7, the determining unit 102 determines whether or not the converted set of identifiers include multiple identifiers having the same value with respect to the communication route converted. That is, the determining unit 102 determines whether or not the converted communication-route candidate involves the overlapping identifiers.

When the identifiers overlap each other (YES in step St7), the determining unit 102 exclude the selected communication-route candidate from the plurality of communication-route candidates in step St9. That is, the determining unit 102 removes the selected communication-route candidate from the communication route information 134. In the case of the example in FIG. 13, since the communication route R10a has the overlapping identifiers “CB7”, the communication route R10a is excluded from the plurality of communication-route candidates.

On the other hand, when the identifiers do not match each other (NO in step St7), the determining unit 102 keeps the selected communication-route candidate in the communication route information 134 in step St8. In the case of the example in FIG. 13, each of the communication routes R10b to R10g involves no overlapping identifiers and is thus not excluded from the plurality of communication-route candidates.

Next, in step St10, the determining unit 102 determines whether or not there is an unselected communication-route candidate. When there is an unselected communication-route candidate (YES in step St10), the determining unit 102 selects the unselected communication-route candidate in step St5 and performs the process in step St6 again.

On the other hand, when there is no unselected communication-route candidate (NO in step St10), the process proceeds to step St11 in which the communication-route designing unit 100 determines, from among the remaining communication-route candidates in the communication route information 134, a communication route for the selected communication channel. In this case, for example, the communication-route designing unit 100 generates a model for a mixed integer programming problem for communication routes and obtains a solution thereof to determine the communication route. The mixed integer programming problem is an analysis method for obtaining a maximum value or a minimum value of an objective function under one or more constraints.

In step St12, based on the demand information 131, the communication-route designing unit 100 determines whether or not there is an unselected communication channel. When there is an unselected communication channel (YES in step St12), the communication-route designing unit 100 selects the unselected communication channel in step St3 and performs the process in step St4 again.

On the other hand, when there is no unselected communication channel (NO in step St12), the process proceeds to step St13 in which the wavelength assigning unit 101 assigns, for each communication channel, wavelengths included in wavelength multiplexing optical signals in the network. In this case, for example, the wavelength assigning unit 101 generates a model for the mixed integer programming problem for wavelengths and obtains a solution to execute wavelength assignment. The constraint for the mixed integer programming problem is that, for example, the same wavelength is not assignable to communication channels that pass through the same main transmission path 911, sub transmission path 910, or auxiliary transmission path 920. In other words, the constraint is that the same wavelength is not assignable to communication channels that share at least part of the communication routes. The wavelength assigning unit 101 writes a result of the wavelength assignment to the HDD 13 as the wavelength assignment information 135.

In step St14, the network design apparatus outputs a design result and then ends the processing. The contents of the communication route information 134 and the wavelength assignment information 135 may also be displayed on the display 170 as a design result. The network design processing is performed in the manner described above.

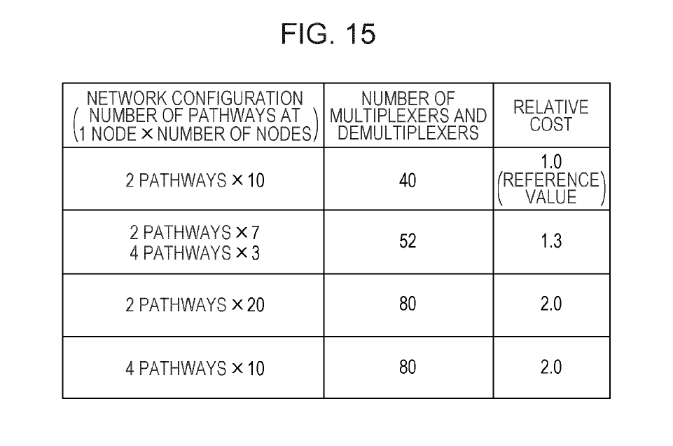

Next, a description will be given of the cost of nodes in a network to be designed. FIG. 15 is a diagram illustrating an example of costs for respective network configurations, according to an embodiment.

The costs illustrated in FIG. 15 are calculated based on the total number of demultiplexers 71a, 71b, and 61 and multiplexers 72a, 72b, and 62 (“the total number of multiplexers and demultiplexers”) illustrated in FIGS. 4 and 5. The wavelength division multiplexing transmission equipment (a ROADM or the like) installed at each node includes optical amplifiers for the respective pathways in order to compensate for loss of optical power of multiplexed optical signals, caused by the demultiplexers and the multiplexers. The demultiplexers, the multiplexers, and the optical amplifiers are expensive, thus greatly affecting the equipment cost. In practice, the equipment cost also includes fixed costs that do not depend on the number of pathways, such as the cost of a power source unit.

Since the wavelength division multiplexing transmission equipment at each general node includes four demultiplexers 71a and 71b and four multiplexers 72a and 72b for four pathways, as illustrated in FIG. 4, the number of multiplexers and demultiplexers is 8. On the other hand, since the wavelength division multiplexing transmission equipment at each local node includes two demultiplexers 61 and two multiplexers 62 for two pathways, as illustrated in FIG. 5, the number of multiplexers and demultiplexers is 4.

Thus, in the case of a network configuration in which ten nodes (corresponding to local nodes), each having two pathways, are provided, the number of multiplexers and demultiplexers is 40. On the assumption that the cost of this network is 1.0 (reference value), the “relative cost” in FIG. 15 indicates the costs of other network configurations. All of the network configurations are assumed to be ring networks.

In the case of a network configuration (see FIG. 3) in which seven nodes (local nodes), each having two pathways, are provided and three nodes (general nodes), each having four pathways, are provided, the number of multiplexers and demultiplexers becomes 52. Thus, the relative cost in this network configuration is 1.3, which is given by the ratio of the multiplexers and demultiplexers (52/40).

In the case of a network configuration (see FIG. 1) in which 20 nodes (corresponding to local nodes), each having two pathways, are provided, the number of multiplexers and demultiplexers is 80. Thus, the relative cost of this network configuration is 2.0, which is given by the ratio of the multiplexers and demultiplexers (80/40).

In the case of a network configuration (see FIG. 2) in which ten nodes (corresponding to general nodes), each having four pathways, are provided, the number of multiplexers and demultiplexers is 80. Thus, the relative cost of this network configuration is 2.0, which is given by the ratio of the multiplexers and demultiplexers (80/40).

Hence, the equipment cost is reduced by 35% when the network illustrated in FIG. 3 is used, compared with a case in which the networks illustrated in FIGS. 1 and 2 are used. Even when compared with the simple network in which ten nodes, each having two pathways, are provided, the network illustrated in FIG. 3 also makes it possible to reduce an increase in the equipment cost up to about 30 (%).

As described above, the network design apparatus includes the generating unit (the communication-route designing unit) 100, the HDD (the storage unit) 13 that stores the table (the route conversion table) 136 therein, and the determining unit 102. The generating unit 100 combines the main transmission paths 911 that provide connections between three or more nodes (local nodes) in the network and the sub transmission paths 910 that provide connections between particular nodes (general nodes) in the network, where the sub transmission paths 910 are accommodated in the communication cables (optical fiber cables) 91 together with the main transmission paths 911. As a result of the combination, the generating unit 100 generates a plurality of communication route candidates for a requested communication channel.

The table 136 indicates association relationship between the main transmission paths 911 and the communication cables 91 accommodating the main transmission paths 911, and association relationship between the sub transmission paths 910 and the communication cables 91 that accommodate the sub transmission paths 910 and are provided at opposite ends of each of the sub transmission paths 910. By referring to the table 136, the determining unit 102 determines, among the plurality of communication-route candidates, a communication-route candidate that uses the same communication cable 91 multiple times, and excludes the determined communication-route candidate from the plurality of communication-route candidates.

According to the configuration described above, the main transmission paths 911 provide connections between three or more nodes in the network, and the sub transmission paths 910 provide connections between particular nodes (general nodes) in the network. Accordingly, the transmission paths between the particular nodes are made redundant, thus making it possible to increase the transmission capacity of the network. Also, since nodes other than the particular nodes are not connected to the sub transmission paths 910, the number of pathways at the nodes is smaller than the number of pathways at the particular nodes, and thus the cost is reduced.

Also, although each sub transmission path 910 is accommodated in a plurality of communication cables 91, the table 136 indicates association relationships with the communication cables 91 provided at opposite ends, not the association relationships with all of the communication cables 91 accommodating the sub transmission paths 910. Thus, since the communication cables 91 that are to be subjected to the determination processing are limited, the determining unit 102 may determine, in a short period of time, a communication-route candidate that uses the same communication cable 91 multiple times.

By referring to the table 136, the determining unit 102 excludes, from the plurality of communication-route candidates, a communication-route candidate that uses the same communication cable 91 multiple times. Hence, the network design apparatus according to the embodiment makes it possible to design a network in which multiple failures are avoided.

Also, the network design method according to the embodiment is a method for causing a computer to execute processes (1) and (2) below.

Process (1): a plurality of communication-route candidates corresponding to a requested communication channel is generated by combining main transmission paths 911 that provide connections between three or more nodes in a network and sub transmission paths 910 that provide connections between particular nodes in the network, the sub transmission paths 910 being accommodated in communication cables 91 together with the main transmission paths 911.

Process (2): a reference is made to a table 136 indicating association relationship between the main transmission paths 911 and the communication cables 91 accommodating the main transmission paths 911 and association relationship between the sub transmission paths 910 and the communication cables 91 that accommodate the sub transmission paths 910 and are provided at opposite ends of each of the sub transmission paths 910. By doing so, a communication-route candidate that uses the same communication cable 91 multiple times is determined from among the plurality of communication-route candidates, and the determined communication-route candidate is excluded from the plurality of communication-route candidates.

The network design method according to the embodiment offers advantages that are the same as or similar to those of the network design apparatus described above, since it is applied to a configuration that is the same as or similar to that of the above-described network design apparatus.

Also, the network design program according to the embodiment is a program for causing a computer to execute processing (1) and (2) below.

Processing (1): a plurality of communication-route candidates corresponding to a requested communication channel is generated by combining main transmission paths 911 that provide connections between three or more nodes in a network and sub transmission paths 910 that provide connections between particular nodes in the network, where the sub transmission paths 910 are accommodated in communication cables 91 together with the main transmission paths 911.

Processing (2): a reference is made to a table 136 indicating association relationship between the main transmission paths 911 and the communication cables 91 accommodating the main transmission paths 911 and association relationship between the sub transmission paths 910 and the communication cables 91 that accommodate the sub transmission paths 910 and are provided at opposite ends of each of the sub transmission paths 910. By doing so, a communication-route candidate that uses the same communication cable 91 multiple times is determined from among the plurality of communication-route candidates, and the determined communication-route candidate is excluded from the plurality of communication-route candidates.

The network design program according to the embodiment offers operational effects that are the same as or similar to those of the network design apparatus described above, since it is applied to a configuration that is the same as or similar to that of the above-described network design apparatus.

Although the contents of the present disclosure have been specifically described above with reference to the preferred embodiments, it is apparent to those skilled in the art that various modification and changes are possible based on the basic technical spirit and the teaching of the present disclosure.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. An apparatus comprising:
a processor configured:
to generate a plurality of communication-route candidates corresponding to a requested communication channel by combining first transmission paths providing connections between particular nodes in a network and second transmission paths providing connections between three or more nodes in the network, the first transmission paths being accommodated in a plurality of communication cables together with the second transmission paths,
to store a table indicating first and second association relationships, the first association relationship associating the first transmission paths with communication cables that accommodate the first transmission paths and are provided at opposite ends of each of the first transmission paths, the second association relationship associating the second transmission paths with communication cables accommodating the second transmission paths, and
to determine, by referring to the table, from among the plurality of communication-route candidates, a communication-route candidate that uses a same communication cable multiple times, and exclude the determined communication-route candidate from the plurality of communication-route candidates; and
a memory coupled to the processor, configured to store information on the communication channel and the first and second transmission paths.

2. The apparatus of claim 1, wherein
a path identifier identifying each of the first and second transmission paths is registered in the table in association with one or more cable identifiers each identifying one of the plurality of communication cables; and
the processor:
converts, by referring to the table, path identifiers identifying the first and second transmission paths included in each of the plurality of communication-route candidates into a set of cable identifiers that are associated with the path identifiers in the table,
determines a communication-route candidate, from among the plurality of communication-route candidates, for which the converted set of cable identifiers includes multiple cable identifiers having a same value, and
excludes the determined communication-route candidate from the plurality of communication-route candidates.

3. A network design method causing a computer to execute a process comprising:
generating a plurality of communication-route candidates corresponding to a requested communication channel by combining first transmission paths providing connections between particular nodes in a network and second transmission paths providing connections between three or more nodes in the network, the first transmission paths being accommodated in a plurality of communication cables together with the second transmission paths;
providing a table indicating first and second association relationships, the first association relationship associating the first transmission paths with communication cables that accommodate the first transmission paths and are provided at opposite ends of each of the first transmission paths, the second association relationship associating the second transmission paths with communication cables accommodating the second transmission paths; and
determining, by referring to the table, from among the plurality of communication-route candidates, a communication-route candidate that uses a same communication cable multiple times, and excluding the determined communication-route candidate from the plurality of communication-route candidates.

4. The network design method of claim 3, wherein the process including registering a path identifier identifying each of the first and second transmission paths in the table in association with one or more cable identifiers each identifying one of the plurality of communication cables; and
the determining includes:
converting, by referring to the table, path identifiers identifying the first and second transmission paths included in each of the plurality of communication-route candidates into a set of cable identifiers that are associated with the path identifiers in the table,
determining a communication-route candidate, from among the plurality of communication-route candidates, for which the converted set of cable identifiers includes multiple cable identifiers having a same value, and
excluding the determined communication-route candidate from the plurality of communication-route candidates.

5. A non-transitory, computer-readable recording medium having stored therein a program for causing a computer to execute a process comprising:
generating a plurality of communication-route candidates corresponding to a requested communication channel by combining first transmission paths providing connections between particular nodes in a network and second transmission paths providing connections between three or more nodes in the network, the first transmission paths being accommodated in a plurality of communication cables together with the second transmission paths;
providing a table indicating first and second association relationships, the first association relationship associating the first transmission paths with communication cables that accommodate the first transmission paths and are provided at opposite ends of each of the first transmission paths, the second association relationship associating the second transmission paths with communication cables accommodating the second transmission paths; and
determining, by referring to the table, from among the plurality of communication-route candidates, a communication-route candidate that uses a same communication cable multiple times, and excluding the determined communication-route candidate from the plurality of communication-route candidates.

6. The non-transitory, computer-readable recording medium of claim 5, wherein
the process further includes registering a path identifier identifying each of the first and second transmission paths in the table in association with one or more cable identifiers each identifying one of the plurality of communication cables second transmission paths and the first transmission paths are registered in the table in association with identifiers of the communication cables; and
the determining includes:
converting, by referring to the table, path identifiers identifying the first and second transmission paths included in each of the plurality of communication-route candidates into a set of cable identifiers that are associated with the path identifiers in the table,
determining a communication-route candidate, from among the plurality of communication-route candidates, for which the converted set of cable identifiers includes multiple cable identifiers having a same value, and
excluding the determined communication-route candidate from the plurality of communication-route candidates.
